(19) United States
(12) Patent Application Publication
(10) Pub. No.: US 2013/0241739 A1
(43) Pub. Date: Sep. 19, 2013

(54) INDICATOR LIGHT CONTROL DEVICE

(71) Applicants: CHUN-SHENG CHEN, Tu-Cheng (TW); HUA ZOU, Wuhan City (CN)

(72) Inventors: CHUN-SHENG CHEN, Tu-Cheng (TW); HUA ZOU, Wuhan City (CN)

(21) Appl. No.: 13/629,656

(22) Filed: Sep. 28, 2012

(30) Foreign Application Priority Data
Mar. 13, 2012 (CN) 201210063985.3

(51) Int. Cl. G08B 5/36

(52) U.S. Cl. 340/815.45; 340/815.4

(57) ABSTRACT

An exemplary indicator light control device includes a motherboard, an indicator control board, and a status indicator unit. The motherboard, the indicator control board, and the status indicator unit are connected in series. The motherboard outputs a first control signal and a second control signal according to an operational status of an electronic device. The indicator control board determines the operational status of the electronic device according to the first and second control signals, and controls operation of the status indicator unit according to the determined operational status of the electronic device.

### BACKGROUND

1. Technical Field

The disclosure generally relates to indicator light control devices, and particularly to an indicator light control device for indicating an operational status of a personal computer (PC).

2. Description of the Related Art

In a PC, an indicator light is usually mounted on a front panel of the PC to indicate an operational status of the PC. For example, when the indicator light is on, the PC is in an S0 state, which means a central processing unit (CPU) of the PC is fully operating and all of devices of the PC are powering up and down as needed. When the indicator light is flickering, the PC is in an S3 state, which means the CPU has no power, a random access memory of the PC is in slow refresh, and a power supply of the PC is generally in a reduced power mode (for example, the power supply not supplying much power and operating in a lower power efficiency mode). When the indicator light is off, the PC is in an S5 state, which means hardware of the PC is completely off, the operating system of the PC has shut down, and nothing has been saved. Apparently, certain parameters of the indicator light, such as its luminance, color, or flicker frequency, are unchangeable, and cannot be adjusted by users according to their needs.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 is a block diagram of an indicator light control device, according to an exemplary embodiment.

FIG. 2 is a circuit diagram of the indicator light control device shown in FIG. 1.

### DETAILED DESCRIPTION

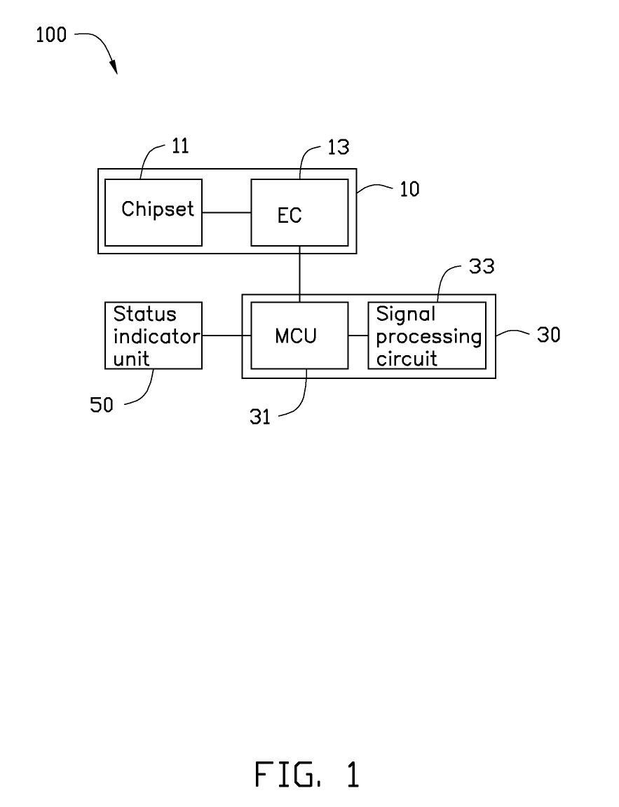

FIG. 1 is a block diagram of an indicator light control device 100, according to an exemplary embodiment. The indicator light control device 100 includes a motherboard 10, an indicator control board 30, and a status indicator unit 50. The motherboard 10, the indicator control board 30, and the status indicator unit 50 are electronically connected in series. The motherboard 10 is mounted in an electronic device (not shown), such as a personal computer, for example. The motherboard 10 outputs a first control signal and a second control signal to the indicator control board 30 according to an operational status of the electronic device. The indicator control board 30 determines the operational status of the electronic device according to the first and second control signals. The indicator control board 30 further controls operation of the status indicator unit 50 according to the determined operational status of the electronic device.

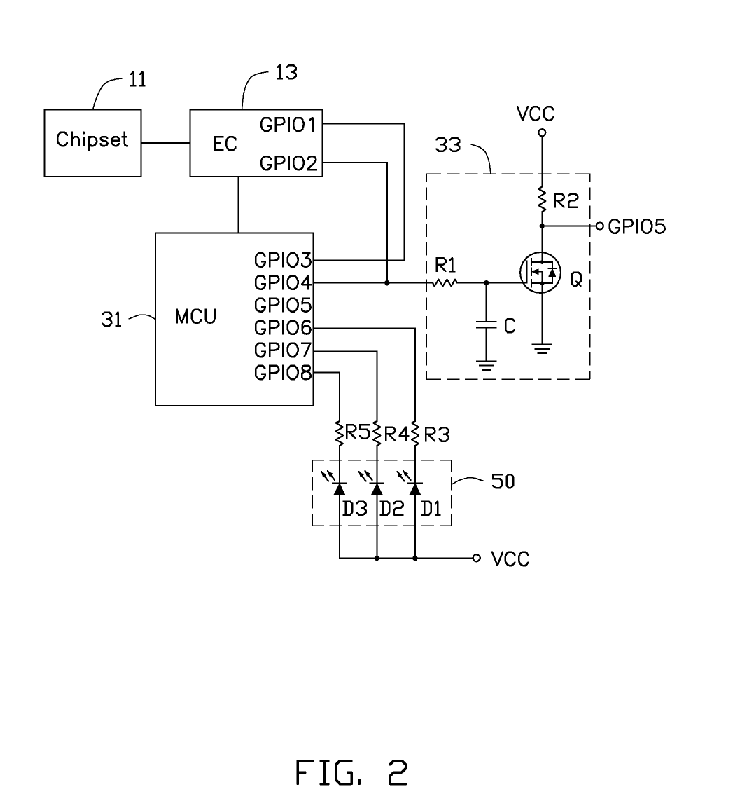

Referring to FIG. 2, the motherboard 10 includes a chipset 11 and an embed controller (EC) 13. The chipset 11 is electronically connected to the EC 13 through a low pin count (LPC) bus. The chipset 11 controls the EC 13 to output the first and second control signals according to the operational status of the electronic device. The EC 13 includes a group of general purpose input output (GPIO) pins GPIO1, GPIO2. The GPIO pin GPIO1 is a first control signal output pin and can output the first control signal under the control of the chipset 11. The GPIO pin GPIO2 is a second control signal output pin and can output the second control signal under the control of the chipset 11.

In detail, when the electronic device is in a first state (e.g., an S0 state), the GPIO pins GPIO1, GPIO2 respectively output a high voltage signal (e.g., logic 1) and a low voltage signal (e.g., logic 0) under the control of the chipset 11, i.e., the first and second control signals are a high voltage signal and a low voltage signal, respectively. When the electronic device is in a second state (e.g., an S3 state), the GPIO pins GPIO1, GPIO2 respectively output a high voltage signal (e.g., logic 1) and a pulse signal under the control of the chipset 11, i.e., the first and second control signals are a high voltage signal and a pulse signal, respectively. When the electronic device is in a third state (e.g., an S5 state), the GPIO pins GPIO1, GPIO2 respectively output a low voltage signal (e.g., logic 0) and a high voltage signal (e.g., logic 1) under the control of the chipset 11, i.e., the first and second control signals are a low voltage signal and a high voltage signal, respectively.

The indicator control board 30 includes a microcontroller (MCU) 31 and a signal processing circuit 33. The MCU 31 includes a group of GPIO pins GPIO3-GPIO8. The GPIO pin GPIO3 is a first control signal receiving pin. The GPIO pin GPIO3 is electronically connected to the GPIO pin GPIO 1 and receives the first control signal from the EC 13. The GPIO pin GPIO4 is a second control signal receiving pin. The GPIO pin GPIO4 is electronically connected to the GPIO pin GPIO2 and receives the second control signal from the EC 13. The GPIO pin GPIO5 is a feedback pin and is electronically connected to the GPIO pin GPIO4 through the signal processing circuit 33. The GPIO pins GPIO6-GPIO8 are control pins and are all electronically connected to the status indicator unit 50.

The signal processing circuit 33 includes a first resistor R1, a second resistor R2, a capacitor C, and a metal-oxide-semiconductor field-effect transistor (MOSFET) Q. A first terminal of the first resistor R1 is connected to the GPIO pin GPIO4. A second terminal of the first resistor R1 is connected to a gate of the MOSFET Q. A first terminal of the capacitor C is connected between the first resistor R1 and the gate of the MOSFET Q. A second terminal of the capacitor C is connected to ground. A source of the MOSFET Q is connected to ground. A drain of the MOSFET Q is connected to a power supply VCC through the second resistor R2. The drain of the MOSFET Q is also connected the GPIO pin GPIO5.

The signal processing circuit 33 processes the second control signal received by the GPIO pin GPIO4 of the MCU 31 and outputs the processed second control signal to the feedback pin (i.e., GPIO pin GPIO5). In detail, when the GPIO pin GPIO4 receives a low voltage signal, the low voltage signal is output to the gate of the MOSFET Q, and the MOSFET Q is turned off. In this way, the GPIO pin GPIO5 of the MCU 31 is connected to the power supply VCC through the second resistor R2 to obtain a high voltage signal. When the GPIO pin GPIO4 receives a high voltage signal, the high voltage signal is output to the gate of the MOSFET Q, and the MOSFET Q is turned on. In this way, the GPIO pin GPIO5 of the MCU 31 is connected to the ground through the MOSFET Q to obtain a low voltage signal. When the GPIO pin GPIO4 receives a pulse signal, the first resistor R1 and the capacitor C will form an integral circuit to transform the pulse signal into a high voltage signal. The transformed high voltage signal is further output to the gate of the MOSFET Q, and the MOSFET Q is turned on. In this way, the GPIO pin GPIO5 of the MCU 31 is connected to the ground through the MOSFET Q to obtain a low voltage signal.

Thus, the MCU 31 can determine an operational status of the electronic device through the GPIO pins GPIO3, GPIO5. For example, when the GPIO pins GPIO3, GPIO5 are both high voltage signals, the MCU 31 determines the electronic device being in the first state. When the GPIO pins GPIO3, GPIO5 are a high voltage signal and a low voltage signal, respectively, the MCU 31 determines the electronic device being in the second state. When the GPIO pins GPIO3, GPIO5 are both low voltage signals, the MCU 31 determines the electronic device being in the third state.

The status indicator unit 50 includes a group of light emitting diodes (LEDs) D1-D3. A cathode of each LED is electronically connected to a corresponding control pin through a resistor. An anode of each LED is electronically connected to the power supply VCC. For example, the cathode of the LED D1 is electronically connected to the control pin (i.e., GPIO pin GPIO6) through a resistor R3. The anode of the LED D1 is electronically connected to the power supply VCC.

The GPIO pins GPIO6-GPIO8 can control the LEDs D1-D3 to emit light with different colors to correspond to different states of the electronic device. For example, when the MCU 31 determines the electronic device being in the first state through the GPIO pins GPIO3, GPIO5, the MCU 31 controls the GPIO pins GPIO6-GPIO8 output a low voltage signal, a high voltage signal, and a high voltage signal, respectively. In this way, the LED D1 is turned on and emits light with a first color (e.g., red light), and the LEDs D2, D3 are turned off, which indicates that the electronic device is in the first state. When the MCU 31 determines the electronic device being in the second state through the GPIO pins GPIO3, GPIO5, the MCU 31 controls the GPIO pins GPIO6-GPIO8 output a high voltage signal, a low voltage signal, and a high voltage signal, respectively. In this way, the LED D2 is turned on and emits light with a second color (e.g., green light), and the LEDs D1, D3 are turned off, which indicates that the electronic device is in the second state. When the MCU 31 determines the electronic device being in the third state through the GPIO pins GPIO3, GPIO5, the MCU 31 controls the GPIO pins GPIO6-GPIO8 output a high voltage signal, a high voltage signal, and a low voltage signal, respectively. In this way, the LED D2 is turned on and emits light with a third color (e.g., blue light), and the LEDs D1, D2 are turned off, which indicates that the electronic device is in the third state.

In use, when the GPIO pins GPIO1, GPIO2 output a high voltage signal and a low voltage signal, respectively, under the control of the chipset 11, the GPIO pins GPIO3, GPIO5 both obtain a high voltage signal. Thus, the MCU 31 determines the electronic device being in the first state. Then, the MCU 31 controls the GPIO pins GPIO6-GPIO8 output a low voltage signal, a high voltage signal, and a high voltage signal, respectively. In this way, the LED D1 is turned on and emits light with the first color, and the LEDs D2, D3 are turned off, which indicates the electronic device is in the first state.

When the GPIO pins GPIO1, GPIO2 output a high voltage signal and a pulse signal, respectively, under the control of the chipset 11, the GPIO pins GPIO3, GPIO5 respectively obtain a high voltage signal and a low voltage signal. Thus, the MCU 31 determines the electronic device being in the second state. Then, the MCU 31 controls the GPIO pins GPIO6-GPIO8 output a high voltage signal, a low voltage signal, and a high voltage signal, respectively. In this way, the LED D2 is turned on and emits light with the second color, and the LEDs D1, D3 are turned off, which indicates the electronic device is in the second state.

When the GPIO pins GPIO1, GPIO2 output a low voltage signal and a high voltage signal, respectively, under the control of the chipset 11, the GPIO pins GPIO3, GPIO5 both obtain a low voltage signal. Thus, the MCU 31 determines the electronic device being in the third state. Then, the MCU 31 controls the GPIO pins GPIO6-GPIO8 output a high voltage signal, a high voltage signal, and a low voltage signal, respectively. In this way, the LED D3 is turned on and emits light with the third color, and the LEDs D1, D2 are turned off, which indicates the electronic device is in the third state.

In summary, in the indicator light control device of this embodiment of the disclosure, the MCU 31 can determine the operational status of the electronic device through the GPIO pins GPIO3, GPIO5, and can further control the operation of the status indicator unit 50 to indicate users through the GPIO pins GPIO6-GPIO8. The indicator light control device has a simple circuit structure, and can adjust certain parameters of the status indicator unit 50 according to the needs of the user, such as color, which is convenient for users to identify an operational status of the electronic device.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in matters of arrangement of parts within the principles of this disclosure to the full extent indicated by the broad general meaning of the terms in which the appended claims are expressed.

What is claimed is:

1. An indicator light control device, comprising:
a motherboard outputting a first control signal and a second control signal according to an operational status of an electronic device;
an indicator control board connected to the motherboard, the indicator control board determining the operational status of the electronic device according to the first and second control signals; and
a status indicator unit connected to the indicator control board; wherein the indicator control board controls operation of the status indicator unit according to the determined operational status of the electronic device.

2. The indicator light control device of claim 1, wherein the motherboard comprises a chipset and an embed controller (EC), the chipset connects to the EC through a low pin count bus and controls the EC to output the first and second control signals according to the operational status of the electronic device.

3. The indicator light control device of claim 2, wherein when the electronic device is in a first state, the chipset controls the first and second control signals being a high voltage signal and a low voltage signal; when the electronic device is in a second state, the chipset controls the first and second control signals being a high voltage signal and a pulse signal; when the electronic device is in a third state, the chipset controls the first and second control signals being a low voltage signal and a high voltage signal.

4. The indicator light control device of claim 2, wherein the EC comprises a first control signal output pin outputting the first control signal and a second control signal output pin outputting the second control signal.

5. The indicator light control device of claim 4, wherein the indicator control board comprises a microcontroller (MCU), the MCU comprises a first control signal receiving pin and a second control signal receiving pin, the first control signal receiving pin is connected to the first control signal output pin to receive the first control signal; the second control signal receiving pin is connected to the second control signal output pin to receive the second control signal.

6. The indicator light control device of claim 5, wherein the indicator control board further comprises a signal processing circuit, the MCU further comprises a feedback pin, the second control signal receiving pin is connected to the feedback pin through the signal processing circuit, the signal processing circuit processes the second control signal from the second control signal receiving pin and outputs the processed second control signal to the MCU, the MCU determines the operational status of the electronic device through the first control signal receiving pin and the feedback pin.

7. The indicator light control device of claim 6, wherein the signal processing circuit comprise a first resistor, a second resistor, a capacitor, and a metal-oxide-semiconductor field-effect transistor (MOSFET), a first terminal of the first resistor is connected to the second control signal receiving pin, a second terminal of the first resistor is connected to a gate of the MOSFET; a first terminal of the capacitor is connected between the first resistor and the gate of the MOSFET, a second terminal of the capacitor is connected to ground; a source of the MOSFET is connected to ground, a drain of the MOSFET is connected to a power supply through the second resistor, and is also connected the feedback pin.

8. The indicator light control device of claim 7, wherein when the second control signal receiving pin receives a low voltage signal, the MCU determines the electronic device being in the first state through the first control signal receiving pin and the feedback pin; when the second control signal receiving pin receives a pulse signal, the MCU determines the electronic device being in the second state through the first control signal receiving pin and the feedback pin; when the second control signal receiving pin receives a high voltage signal, the MCU determines the electronic device being in the third state through the first control signal receiving pin and the feedback pin.

9. The indicator light control device of claim 5, wherein the MCU further comprises a group of control pins, the status indicator unit comprises a group of light emitting diodes (LEDs) corresponding to the control pins; an anode of each LED is connected to a power supply, a cathode of each LED is connected to a corresponding control pin; the MCU controls the operation of the plurality of LEDs to indicate users through the control pins.

10. The indicator light control device of claim 9, wherein the plurality of LEDs can emit light with different colors to correspond to different states of the electronic device.

11. An indicator light control device, comprising:
a motherboard outputting at least one control signal according to an operational status of an electronic device:
an indicator control board connected to the motherboard and comprising a microcontroller (MCU), the MCU comprising a plurality of control pins; and
a status indicator unit connected to the indicator control board and comprising a plurality of light emitting diodes (LEDs) corresponding to the control pins;
wherein the indicator control board determines the operational status of the electronic device according to the at least one control signal, and further controls the plurality of LEDs to turn on or off through the control pins according to the determined operational status of the electronic device.

12. The indicator light control device of claim 11, wherein the motherboard comprises a chipset and an embed controller (EC), the chipset is connected to the EC through a low pin count bus and controls the EC to output a first control signal and a second control signal according to the operational status of the electronic device.

13. The indicator light control device of claim 12, wherein the EC comprises a first control signal output pin outputting the first control signal and a second control signal output pin outputting the second control signal.

14. The indicator light control device of claim 13, wherein the MCU further comprises a first control signal receiving pin and a second control signal receiving pin, the first control signal receiving pin is connected to the first control signal output pin to receive the first control signal; the second control signal receiving pin is connected to the second control signal output pin to receive the second control signal.

15. The indicator light control device of claim 14, wherein the indicator control board further comprises a signal processing circuit, the MCU further comprises a feedback pin, the second control signal receiving pin is connected to the feedback pin through the signal processing circuit, the signal processing circuit processes the second control signal from the second control signal receiving pin and outputs the processed second control signal to the MCU, the MCU determines the operational status of the electronic device through the first control signal receiving pin and the feedback pin.

16. The indicator light control device of claim 15, wherein the signal processing circuit comprise a first resistor, a second resistor, a capacitor, and a metal-oxide-semiconductor field-effect transistor (MOSFET), a first terminal of the first resistor is connected to the second control signal receiving pin, a second terminal of the first resistor is connected to a gate of the MOSFET; a first terminal of the capacitor is connected between the first resistor and the gate of the MOSFET, a second terminal of the capacitor is connected to ground; a source of the MOSFET is connected to ground, a drain of the MOSFET is connected to a power supply through the second resistor, and is also connected the feedback pin.

17. The indicator light control device of claim 11, wherein an anode of each LED is connected to a power supply, a cathode of each LED is connected to a corresponding control pin.

18. The indicator light control device of claim 11, wherein the plurality of LEDs can emit light with different colors to correspond to different states of the electronic device.
